(19) United States
(12) Patent Application Publication
(10) Pub. No.: US 2012/0163267 A1
(43) Pub. Date: Jun. 28, 2012

(54) METHOD AND SYSTEM FOR RECEIVING MULTICAST DATA IN TUNNELLING-BASED MOBILITY NETWORK ARCHITECTURE, AND MOBILE TERMINAL THEREOF

(75) Inventors: Seong Moon, Daejeon (KR); Ho Yong Ryu, Daejeon (KR); Pyung Koo Park, Daejeon (KR)

(73) Assignee: ELECTRONICS AND TELECOMMUNICATIONS RESEARCH INSTITUTE, Daejeon (KR)

(21) Appl. No.: 13/294,477

(22) Filed: Nov. 11, 2011

(30) Foreign Application Priority Data
Dec. 23, 2010 (KR) 10-2010-0134067

(51) Int. Cl. H04H 20/71

(52) U.S. Cl. 370/312

(57) ABSTRACT

Disclosed are a method and a system for receiving multicast data without using a tunnel in a tunneling-based mobility network architecture, and a mobile terminal thereof. By providing a method for receiving multicast data in a tunneling-based mobility network architecture receiving multicast data over a multicast-enabled Internet protocol (IP) network by switching a path before tunneling and thereby transmitting a corresponding channel reception request message to a corresponding visit network when a transmission packet of a mobile terminal is a channel reception request message in a heterogeneous visit network, and at the same time, guaranteeing mobility of the mobile terminal by tunneling a corresponding transmission packet to a care-of-address of a visit network being currently visited when the transmission packet is not the channel reception request message, there are provided a method and a system for receiving multicast data via a visit network without using an existing tunnel.

### CROSS-REFERENCE TO RELATED APPLICATIONS

This application claims priority to and the benefit of Korean Patent Application No. 10-2010-0134067 filed in the Korean Intellectual Property Office on Dec. 23, 2010, the entire contents of which are incorporated herein by reference.

### TECHNICAL FIELD

The present invention relates to a method and a system for receiving multicast data, and a mobile terminal thereof, and more particularly, to a method and a system for receiving multicast data without using a tunnel in a tunneling-based mobility network architecture, and a mobile terminal thereof.

### BACKGROUND

A multicast technology of the Internet is a technology for providing a transmission service with effectively using the bandwidth with respect to a plurality of users. Currently, as uses of broadcasting/audio streaming, video conference, online games, and the like increase, the realization in a wireless mobile communication network such as third generation (3G), wireless fidelity (WiFi), or wireless broadband Internet (WiBro), as compared to a wired communication network, has received a great attention.

Meanwhile, to provide mobility of a mobile terminal in a heterogeneous network, such as 3G or WiFi, having a different communication standard, a packet is transmitted and received using a scheme of tunneling a home-address to a care-of-address of a current visit network.

In order to transmit multicast data to the mobile terminal of which mobility between heterogeneous networks is guaranteed using the above scheme, multicast was serviced to the mobile terminal in the conventional art using a scheme of loading multicast data in a tunnel and thereby carrying the multicast data.

However, the above scheme may provide a seamless network service in the visit network. However, the above scheme has a configuration of copying a multicast packet and transmitting the multicast packet to each mobile terminal desiring to receive the multicast packet according to a unicast scheme as the number of mobile terminals increases. Accordingly, there was a problem in that load occurs in a mobility supporting server, a router, and the like, realizing the above scheme, and unnecessary traffic of a network increases.

### SUMMARY

The present invention has been made in an effort to provide a method and a system for receiving multicast data in a tunneling-based mobility network architecture that can decrease load according to transmission of multicast data and prevent unnecessary traffic inflow from increasing in a network without using the existing tunnel with respect to multicast data and with providing mobility between heterogeneous networks, and a mobile terminal thereof.

An exemplary embodiment of the present invention provides a method for receiving multicast data in a tunneling-based mobility network architecture, receiving multicast data over a multicast-enabled Internet protocol (IP) network by switching a path before tunneling and thereby transmitting a corresponding channel reception request message to a corresponding visit network when a transmission packet of a mobile terminal is a channel reception request message in a heterogeneous visit network, and at the same time, guaranteeing mobility of the mobile terminal by tunneling a corresponding transmission packet to a care-of-address of a visit network being currently visited when the transmission packet is not the channel reception request message.

In this instance, a method for transmitting the multicast channel reception request message to the corresponding visit network may include: a) determining whether the transmission packet is the channel reception request message by monitoring the transmission packet of the mobile terminal ; b) switching the path to transmit the channel reception request message to the visit network when the transmission packet corresponds to the channel reception request message; c) transmitting the path-switched channel reception request message to an interface unit activated in the visit network; and d) transferring the channel reception request message to the visit network via the interface unit.

The a) may include: encapsulating and thereby tunneling the transmission packet when the transmission packet does not correspond to the channel reception request message; and guaranteeing the mobility by transmitting the tunneled transmission packet.

In the c), the reception request message may be transmitted to the interface unit by a program supporting an interface with the visit network.

The c) may further include registering, to a reception state table, information regarding whether reception request information about a corresponding channel exists based on the channel reception request message.

The multicast data is received based on the reception state table.

The visit network may be any one of a wireless-fidelity (WiFi) scheme, a third generation (3G) scheme, and an Ethernet scheme.

Another exemplary embodiment of the present invention provides a mobile terminal for receiving multicast data in a tunneling-based mobility network architecture, including: a multicast data receiver to transmit a channel reception request message requesting reception of predetermined multicast data; a tunnel interface unit to determine whether a corresponding transmission packet is the channel reception request message by monitoring a transmission packet, to switch a path without tunneling when the corresponding transmission packet is determined as the channel reception request message, and to tunnel and thereby transmit the corresponding transmission packet when the corresponding transmission packet is not the channel reception request message; and a visit network mobility supporting unit to receive the channel reception request message from the tunnel interface unit, and to transmit the channel reception request message to a current visit network.

The visit network mobility supporting unit may include an interface unit activated in the current visit network.

The mobile terminal may further include a database (DB) to store a reception state table in which reception request information about a corresponding channel is registered based on the channel reception request message.

The visit network may be any one of a WiFi scheme, a 3G scheme, and an Ethernet scheme.

Yet another exemplary embodiment of the present invention provides a system for receiving multicast data in a tunneling-based mobility network architecture, the system including: a mobility supporting server to tunnel a home address to a care-of-address of a mobile terminal, and to thereby provide mobility of the mobile terminal in a heterogeneous visit network; and a terminating router to transfer, to a visit network at which the mobile terminal is currently positioned, a channel reception request message in a transmission packet of the mobile terminal, to receive corresponding multicast data from a multicast broadcasting source over a multicast-enabled IP network in correspondence to the reception request message and thereby transmit the corresponding multicast data to the mobile terminal, and to transmit, to the mobility supporting server, a tunneled transmission packet excluding the channel reception request message in the transmission packet of the mobility terminal.

The visit network may be any one of a WiFi scheme, a 3G scheme, and an Ethernet scheme.

According to the exemplary embodiments of the present invention, a method and system for receiving multicast data in a tunneling-based mobility network architecture and a mobile terminal thereof include a method and a system for receiving multicast data over a visit network without using the existing tunnel. Accordingly, even though a mobile terminal moves to a heterogeneous network, there is provided the effect of minimizing load in a system such as a router and the like, and preventing unnecessary traffic from occurring in a network with receiving seamless multicast.

### BRIEF DESCRIPTION OF THE DRAWINGS

FIG. 1 is a conceptual diagram schematically illustrating the entire system to describe a configuration of receiving multicast data in a tunneling-based mobility network architecture according to an exemplary embodiment of the present invention;

FIG. 2 is a flowchart to describe an embodiment of a method for receiving multicast data in a tunneling-based mobility network architecture according to an exemplary embodiment of the present invention; and

FIG. 3 is a conceptual block diagram to describe a configuration of a mobile terminal for receiving multicast data in a tunneling-based mobility network architecture according to an exemplary embodiment of the present invention.

### DETAILED DESCRIPTION

Hereinafter, exemplary embodiments of the present invention will be described in detail with reference to the accompanying drawings. In this description, when any one element is connected to another element, the corresponding element may be connected directly to another element or with a third element interposed therebetween. First of all, it is to be noted that in giving reference numerals to elements of each drawing, like reference numerals refer to like elements even though like elements are shown in different drawings. The components and operations of the present invention illustrated in the drawings and described with reference to the drawings are described as at least one exemplary embodiment and the spirit and the core components and operation of the present invention are not limited thereto.

Hereinafter, an exemplary embodiment of a method and a system for receiving multicast data in a tunneling-based mobility network architecture according to an exemplary embodiment of the present invention, and a mobile terminal thereof will be described.

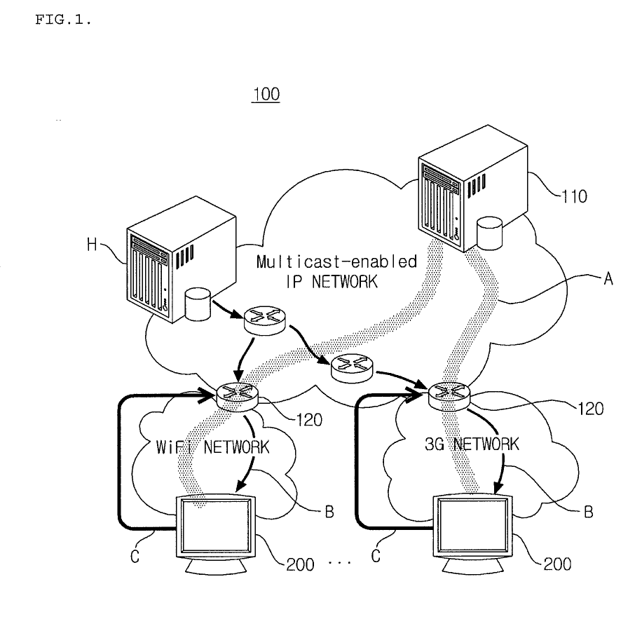

FIG. 1 is a conceptual diagram schematically illustrating the entire system to describe a configuration of receiving multicast data in a tunneling-based mobility network architecture according to an exemplary embodiment of the present invention.

A configuration of a multicast data receiving system 100 in a tunneling-based mobility network architecture according to the exemplary embodiment of the present invention will be initially described with reference to FIG. 1.

As shown in FIG. 1, the exemplary embodiment includes a configuration of transferring multicast data to a network (wireless fidelity (WiFi) network, a third generation (3G) network, an Ethernet network, etc.) in which a mobile terminal 200 does not use an existing tunnel to receive multicast data and is positioned over a multicast-enabled Internet protocol (IP) network as shown in B of FIG. 1. In addition, the exemplary embodiment maintains communication using an active tunnel as shown in A of FIG. 1 in order to support the mobility of the mobile terminal 200 moving to a heterogeneous visit network.

Here, the multicast-enabled IP network indicates an IP network in which a multicast tree is formed between routers supporting multicast.

The exemplary embodiment includes a mobility supporting server 110 to support the mobility of the mobile terminal 200 moving to the heterogeneous visit network, and the mobility supporting server 110 supports the mobility by tunneling a multicast home address to a care-of-address of the mobile terminal 200.

Even though the mobile terminal 200 moves to the heterogeneous visit network through signaling with the mobility supporting server 110, the network connectivity of the mobile terminal 200 is continuously guaranteed.

For example, when the mobile terminal 200 moves from a WiFi network region to a 3G network region and thereby, the signal quality with respect to a WiFi network deteriorates, the mobile terminal 200 switches an activated tunnel from the WiFi network to a 3G network through signaling with the mobility supporting server 110.

In the meantime, a process of receiving, by the mobile terminal 200, multicast data according to the exemplary embodiment will be described.

When the mobile terminal 200 transmits a channel reception request message to a corresponding visit network as shown in C of FIG. 1 with moving to the heterogeneous visit network (e.g., from the 3G network to the WiFi network, or from the WiFi network to the 3G network), the transmitted channel reception request message is transferred to a terminating router 120.

The terminating router 120 maps a multicast address of a multicast broadcasting source H and a multicast address of the channel reception request message and thereby transmits multicast data. Accordingly, corresponding multicast data is transferred from the multicast broadcasting source H to the terminating router 120 over the multicast-enabled IP network.

Thus, the terminating router 120 transfers the transferred multicast data to the mobile terminal 200 by transmitting the transferred multicast data to a visit network being currently visited by the mobile terminal 200.

Hereinafter, as described above, a multicast data receiving method in which the mobile terminal 200 does not transmit the channel reception request message to the mobility supporting server 110 using a tunnel and the channel reception request message is transferred to a visit network being currently visited by the mobile terminal 200 will be described. Also, a configuration of the mobile terminal 200 realizing this will be described.

An exemplary embodiment of the present invention provides a method for receiving multicast data in tunneling-based mobility network architecture, receiving transmission of multicast data over a multicast-enabled Internet protocol (IP) network by switching a path before tunneling and thereby transmitting a corresponding channel reception request message to a corresponding visit network when a transmission packet of a mobile terminal is a channel reception request message in a heterogeneous visit network, and at the same time, guaranteeing mobility of the mobile terminal by tunneling a corresponding transmission packet to a care-of-address of a visit network being currently visited when the transmission packet is not the channel reception request message.

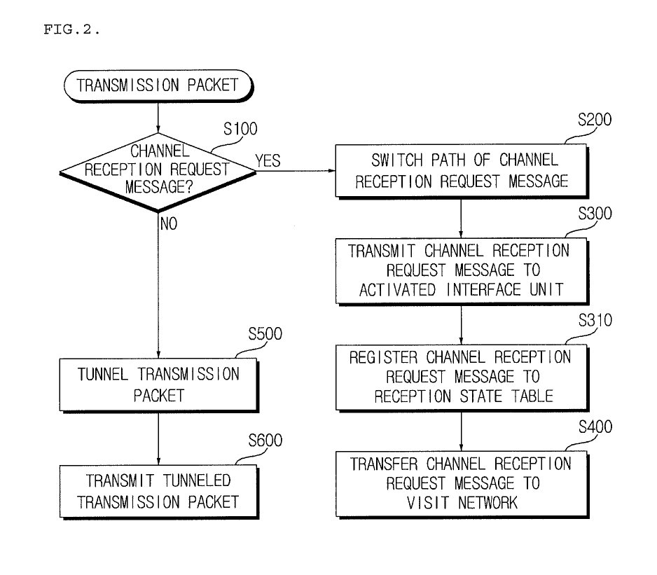

A method for transmitting a multicast channel reception request message to a corresponding visit network according to an exemplary embodiment of the present invention will be described with reference to FIG. 2.

FIG. 2 is a flowchart to describe an embodiment of a method for transmitting a multicast channel reception message to a corresponding visit network according to an exemplary embodiment of the present invention.

Initially, whether a transmission packet is a channel reception request message is determined by monitoring the transmission packet of the mobile terminal 200 (S100). The channel reception request message is identifiable using a header format.

When the transmission packet corresponds to the channel reception request message, a path of the channel reception request message is switched to transmit the channel reception request message to a visit network (a WiFi network or a 3G network) being currently visited by the mobile terminal 200 (S200). That is, when the transmission packet is determined as the channel reception request message, the channel reception request message is transferred using a mobility supporting client program of the mobility terminal 200 without tunneling. Here, the mobility supporting program is a program for supporting an interface between the mobile terminal 200 and the visit network.

Next, the path-switched channel reception request message is transmitted to an interface unit activated in the visit network (S300). That is, the mobility supporting program of the mobile terminal 200 transmits a corresponding channel reception request message to the interface unit activated in correspondence to a current visit network.

Also, information regarding that a reception request about a corresponding channel exists is registered to a reception state table based on the corresponding channel reception request message (S310). This is to verify whether received multicast data is multicast data of the requested corresponding channel when receiving the multicast data.

Next, the channel reception request message is transferred to the visit network via the interface unit (S400). Accordingly, the visit network being currently visited by the mobile terminal 200 recognizes that a channel reception request exists.

Meanwhile, when the transmission packet of the mobile terminal 200 does not correspond to the channel reception request message in the aforementioned operation S100, the transmission packet is encapsulated and thereby is tunneled (S500).

The mobility of the mobile terminal 200 is guaranteed by transmitting the tunneled transmission packet to the mobility supporting server 110 (S600).

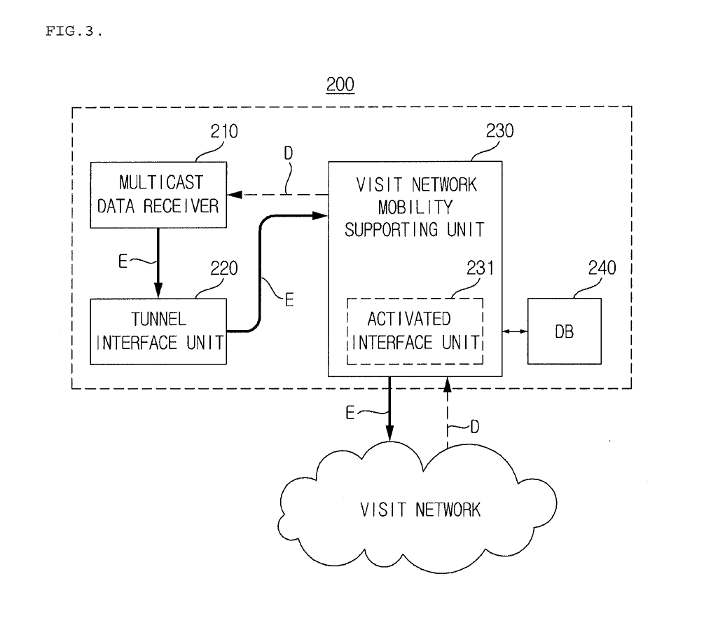

Hereinafter, a configuration of the mobile terminal 200 realizing the method for transmitting the multicast channel reception request message to the corresponding visit network as described above will be described with reference to FIG. 3.

FIG. 3 is a conceptual block diagram to describe a configuration of a mobile terminal 200 for receiving multicast data in a tunneling-based mobility network architecture according to an exemplary embodiment of the present invention.

As shown in FIG. 3, the mobile terminal 200 according to the exemplary embodiment of the present invention includes a data receiver 210 to transmit a channel reception request message and receive multicast data, a tunnel interface unit 220 to switch a path of the channel reception request message, and a visit network mobility supporting unit 230 to transmit the channel reception request message to a visit network.

The data receiver 210 corresponds to a constituent element to drive an application for receiving multicast data, and functions to transmit, to the tunnel interface unit 220, the channel reception request message desiring reception of predetermined multicast data. Further, the data receiver 210 receives multicast data transmitted by the channel reception request message. This data receiver 210 does not limit a reception interface with respect to a predetermined channel and receives multicast data based on a destination address and port information and thus, may receive multicast data without using the tunnel interface unit 220 as shown in D of FIG. 3.

The tunnel interface unit 220 functions to determine whether a corresponding transmission packet is the channel reception request message transmitted from the data receiver 210 by monitoring a transmission packet, and to switch a path of the channel reception request message when the transmission packet is determined as the channel reception request message. That is, when it is determined whether the transmission packet is the channel reception request message, the path is switched to the visit network mobility supporting unit 230 as shown in E of FIG. 3 without tunneling, and thereby the channel reception request message is transmitted. The channel reception request message is identifiable using a header format.

On the other hand, when the transmission packet is not the channel reception request message, the tunnel interface unit 220 transmits the corresponding transmission packet to the mobility supporting server 110 by tunneling the corresponding transmission packet.

The visit network mobility supporting unit 230 functions to enable a visit network to recognize the channel reception request message by receiving the channel reception request message of which the path is switched by the aforementioned tunnel interface unit 220, and by transmitting the channel reception request message to a current visit network. Such visit network mobility supporting unit 230 transfers the channel reception request message to the terminating router 120 via an interface unit 231 activated in the visit network such as a WiFi network, a 3G network, an Ethernet network, and the like.

Meanwhile, it is desirable to include a database (DB) 240 storing a reception state table in which reception request information about a corresponding channel is registered based on the channel reception request message. Since information regarding that multicast data about the corresponding channel is to be received is recorded in the DB 240 storing the reception state table, it is possible to verify multicast data received by the mobile terminal 200 and thereby transfer the verified multicast data to the aforementioned data receiver 210.

The visit network to which the above mobile terminal 200 moves may be configured using a WiFi network, a 3G network, an Ethernet network, and the like.

As described above, the exemplary embodiments have been described and illustrated in the drawings and the specification. Herein, specific terms have been used, but are just used for the purpose of describing the present invention and are not used for defining the meaning or limiting the scope of the present invention, which is disclosed in the appended claims. Therefore, it will be appreciated to those skilled in the art that various modifications are made and other equivalent embodiments are available. Accordingly, the actual technical protection scope of the present invention must be determined by the spirit of the appended claims.

What is claimed is:

1. A method for receiving multicast data in a tunneling-based mobility network architecture, receiving multicast data over a multicast-enabled Internet protocol (IP) network by switching a path before tunneling and thereby transmitting a corresponding channel reception request message to a corresponding visit network when a transmission packet of a mobile terminal is a channel reception request message in a heterogeneous visit network, and at the same time, guaranteeing mobility of the mobile terminal by tunneling a corresponding transmission packet to a care-of-address of a visit network being currently visited when the transmission packet is not the channel reception request message.

2. The method of claim 1, wherein a method for transmitting the multicast channel reception request message to the corresponding visit network comprises:
a) determining whether the transmission packet is the channel reception request message by monitoring the transmission packet of the mobile terminal;
b) switching the path to transmit the channel reception request message to the visit network when the transmission packet corresponds to the channel reception request message;
c) transmitting the path-switched channel reception request message to an interface unit activated in the visit network; and
d) transferring the channel reception request message to the visit network via the interface unit.

3. The method of claim 2, wherein the a) comprises:
tunneling the transmission packet to the care-of-address of the visit network when the transmission packet does not correspond to the channel reception request message; and
guaranteeing the mobility by transmitting the tunneled transmission packet.

4. The method of claim 2, wherein, in the c), the reception request message is transmitted to the interface unit by a program supporting an interface with the visit network.

5. The method of claim 2, wherein the c) further comprises:
registering, to a reception state table, information regarding whether reception request information about a corresponding channel exists based on the channel reception request message.

6. The method of claim 5, wherein the multicast data is received based on the reception state table.

7. The method of claim 1, wherein the visit network is any one of a wireless-fidelity (WiFi) scheme, a third generation (3G) scheme, and an Ethernet scheme.

8. A mobile terminal for receiving multicast data in a tunneling-based mobility network architecture, comprising:
a multicast data receiver to transmit a channel reception request message requesting reception of predetermined multicast data;
a tunnel interface unit to determine whether a corresponding transmission packet is the channel reception request message by monitoring a transmission packet, to switch a path without tunneling when the corresponding transmission packet is determined as the channel reception request message, and to tunnel and thereby transmit the corresponding transmission packet when the corresponding transmission packet is not the channel reception request message; and
a visit network mobility supporting unit to receive the channel reception request message from the tunnel interface unit, and to transmit the channel reception request message to a current visit network.

9. The mobile terminal of claim 8, wherein the visit network mobility supporting unit comprises an interface unit activated in the current visit network.

10. The mobile terminal of claim 8, further comprising:
a database to store a reception state table in which reception request information about a corresponding channel is registered based on the channel reception request message.

11. The mobile terminal of claim 8, wherein the visit network is any one of a WiFi scheme, a 3G scheme, and an Ethernet scheme.

12. A system for receiving multicast data in a tunneling-based mobility network architecture, the system comprising:
a mobility supporting server to tunnel a home address to a care-of-address of a mobile terminal, and to thereby provide mobility of the mobile terminal in a heterogeneous visit network; and
a terminating router to transfer, to a visit network at which the mobile terminal is currently positioned, a channel reception request message in a transmission packet of the mobile terminal, to receive corresponding multicast data from a multicast broadcasting source over a multicast-enabled IP network in correspondence to the reception request message and thereby transmit the corresponding multicast data to the mobile terminal, and to transmit, to the mobility supporting server, a tunneled transmission packet excluding the channel reception request message in the transmission packet of the mobility terminal.

13. The system of claim 12, wherein the visit network is any one of a WiFi scheme, a 3G scheme, and an Ethernet scheme.
